(19) United States
(12) Patent Application Publication
(10) Pub. No.: US 2012/0182994 A1
(43) Pub. Date: Jul. 19, 2012

(54) ADDRESS COMPATIBILITY IN A NETWORK DEVICE RELOAD

(75) Inventors: Wojciech Dec, Amsterdam (NL); Thomas Kernen, Russin (CH); Eric Vyncke, Alleur (BE)

(73) Assignee: Cisco Technology, Inc., San Jose, CA (US)

(21) Appl. No.: 13/008,630

(22) Filed: Jan. 18, 2011

(51) Int. Cl. H04L 12/56

(52) U.S. Cl. 370/392

(57) ABSTRACT

In one embodiment, a network device maintains address compatibility in a reload. The reload results from a reconnect event such as a reboot or a software upgrade. Before the reload, the network device establishes communication using a first address prefix. Because of the reload, the first address prefix is cleared from the network device. The service provider may provide a second address prefix. Rather than advertise the second address prefix, the network device waits for traffic from the hosts. If the hosts continue to use the first address prefix, the network device requests the first address prefix be re-assigned by the service provider. If the service provider does not re-assign the first address prefix, the network device may advertise the first address prefix in a router advertisement including a relatively short preferred lifetime. The short preferred lifetime prevents the use of the old address prefix.

### FIELD

The present disclosure relates to network device reloads.

### BACKGROUND

The address space of the current version of internet protocol (IPv4) will soon be exhausted. The transition to Internet Protocol Version 6 (IPv6) is gaining momentum. The address space of IPv6 has about 3.4×10³⁸ addresses, which provides flexibility in address allocation. Address allocation has generally been done sparingly, and addresses in homes or other local area networks (LANs) are rationed because of the worldwide realization that IPv4 addresses would be exhausted. Rationing may be provided through network address translation. Network address translation modifies address information in packet headers while in transit in order to remap one address space into another. For example, all of the computers in a LAN may appear to have the same address to the rest of the Internet. A network device of the LAN modifies the addresses of packets as they come into the LAN so that the packets reach the appropriate devices within the LAN.

However, in IPv6, the many host devices on a LAN may have unique global addresses. Under IPv6, network address translation is not necessary for rationing reasons, but network devices still connect the LAN to the service provider and route the traffic to the host devices. When a service provider changes the addresses available to the host devices, conventional neighbor discovery protocols may not permit the devices to accurately update their IPv6 addresses.

### BRIEF DESCRIPTION OF THE DRAWINGS

FIG. 1 illustrates an example network including a network device for maintaining address compatibility in a network device reload.

FIG. 2 illustrates an example embodiment of recovering addresses following a network device reload.

FIG. 3 illustrates an example embodiment of invalidating addresses following a network device reload.

FIG. 4 illustrates a flow chart, according to one embodiment, for maintaining address compatibility in a network device reload.

FIG. 5 illustrates a flow chart, according to another embodiment, for maintaining address compatibility in a network device reload.

FIG. 6 illustrates a block diagram of the network device of FIGS. 1-3.

### DETAILED DESCRIPTION

### Overview

In some deployments, a reload of a network device, such as a residential gateway, results in hosts continuing to use an old address prefix, while the network device advertises a new address prefix supplied from the service provider. Typically, this results in network traffic being dropped. However, the network device may be configured to maintain address compatibility during the network device reload by waiting for traffic from the hosts rather than immediately requesting a new address prefix and advertising the new address prefix to the attached LAN hosts. If the hosts continue to use the old address prefix, the network device may request that the service provider re-assign the old address prefix. If the service provider does not comply or is unable to comply, the network device generates a router advertisement message that sets the preferred lifetime of the old address prefix (learned from packets from hosts) to zero or a relatively short value and the preferred lifetime of the new address prefix to the default value. Accordingly, the hosts prefer or use the new address prefix. This solution relies on no functionality on any of the hosts except the general adherence to RFC 4292, which has been adopted in most networks. In addition, the solution is transparent to end users and may require no user involvement.

In one aspect, a method by one or more computer systems includes, as part of a reconnect event, clearing from a memory of a network device, a first address prefix being used at least in part to provide connectivity between the network device and at least one host device, receiving a second address prefix from a provider, delaying transmission of a network discovery message including the second address prefix for a period, and receiving a message from the at least one host device during the period, wherein the message includes the first address prefix.

In a second aspect, a network device includes a communication interface and a controller. The communication interface establishes connectivity with at least one host device using a first address prefix received from a service provider. The controller is configured to perform a reconnect event, wherein the first address prefix is cleared from the network device as part of the reconnect event, and configured to delay transmission of a network discovery message including a second address prefix received from for the service provider.

In a third aspect, computer readable storage media are encoded with software comprising computer executable instructions operable to communicate with at least one host device using a first address prefix, receive a second address prefix from an external device, and receive a message including the first address prefix from the at least one host device during a delay period after receiving the second address prefix, wherein the transmission of a network discovery message including the second address prefix is prevented during the delay period.

### Example Embodiments

A network is made up of links and nodes. A link is any communication medium over which nodes can communicate. Nodes on the same link use neighbor discovery to discover the presence of other nodes and to maintain reachability information about the paths to active neighboring nodes. Nodes may be hosts or network devices (e.g. router, gateway, etc.). A network device is any node that forwards packets not explicitly addressed to the network device as the destination. A host is any node that is not a network device.

Neighbor discovery messages include neighbor and router solicitations and advertisements. Router solicitations request routers to generate router advertisements. Router advertisements list the presence of the sending router. Router advertisements include prefixes for determining whether another address shares the same link, configuration, hop limit, or other parameters. Router advertisements may be in the format defined by RFC 4861, released September 2007 and available at http://tools.ietf.org/html/rfc4861, which includes an options format. The options format may list a prefix and a preferred lifetime. The preferred lifetime may be a length of time measured in seconds, relative to the time the packet is sent, that any address generated from the prefix remains preferred. The preferred lifetime may be from 0 to infinity.

Addresses configured through stateless address autoconfiguration can be used until the preferred lifetime from the router advertisement message expires. In most cases, the lifetime does not expire because new router advertisements restart the timers. But if the network device stops generated router advertisements or if the preferred lifetime is set to a relatively small value, eventually the preferred lifetime elapses and the address becomes deprecated. Hosts are configured to avoid using deprecated addresses for new connections.

Network address translation involves modifying address information in packet headers while in transit across a network device in order to remap one address space into another. For example, all of the nodes in a network may appear to have the same address (the address of the network device) to the rest of the Internet because a network device modifies the addresses of packets as they leave the network so that the packets reach the appropriate devices.

A residential gateway is an example of a network device. The residential gateway may utilize network address translation so that all of the hosts within the residential network appear as one address to nodes outside of the residential network. The term “residential” originally indicated that the residential gateway was intended for home environments as opposed to the more sophisticated network devices used in corporate environments. However, the distinctions between residential gateways and other network devices have diminished, and similar network devices are used in homes, businesses, campuses, or any environment.

The network device or residential gateway may also be referred to as customer premises equipment (CPE) or (CP), which is a term rooted in the practice of the telephone (or other telecommunications) company providing customers with equipment and preventing customers from connecting their own equipment to the network. The use of the CP equipment and residential gateway varies geographically but either type of device may implement the following embodiments. Other gateways, such as in the corporate environment, may implement the following embodiments.

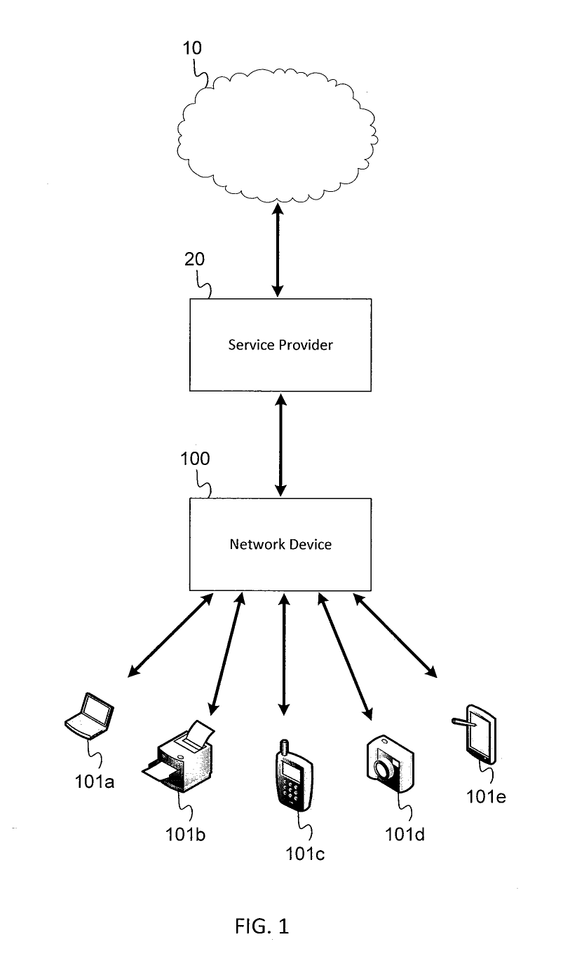

FIG. 1 illustrates a network including a network device 100 for maintaining address compatibility in a network device reload. The network device 100 connects to an external network 10 through a service provider 20. The external network may be the Internet. The service provider 20 may provide a connection to the external network through a digital subscriber line (DSL), a coaxial line, a wireless signal, an optical fiber line or any communication medium capable of supplying a broadband connection. The network device 100 communicates with a plurality of hosts. For example, the hosts may include one or more devices, such as a computer 101a, a printer 101b, a mobile phone 101c, a camera 101d, a table computer 101e, or any device capable of communicating with a network.

The network device 100 facilitates communication between hosts 101 to the external network 10 by assigning addresses to the hosts 101. The network device 100 is assigned addresses by the service provider 20. When the network device 100 reboots, the network device 100 loses the addresses of the hosts 101. The loss of addresses may be because the network device 100 lacks a memory or is otherwise not configured to store addresses during a power off or because the network device 100 is configured to clear addresses during a power off. The address may be an entire IPv6 address, a partial address or a prefix.

After rebooting, the network device 100 may request a set of addresses (known as the prefix) from the service provider 20. The addresses received from the service provider 20 may not match the old addresses. The service provider 20 may want to change the addresses periodically, such as weekly or daily, or at any reconnect event that results in a network device reload. The reconnect event may be a reboot, a reconfiguration, a software upgrade, or a hardware upgrade.

The change in address may result from a technical reason or from a business reason. An example technical reason may be that the service provider 20 comprises many routers and the network device 100 may not communicate with the same router or server after the reconnect event as before the reconnect event. The two servers or routers may have different addresses based on their respective locations on the network of the service provider 20. Another technical reason may be a loss of the DHCPv6 state on the server. This occurs when the DHCPv6 server is upgraded, changed, reconfigured or moved to another location. Loss of the DHCPv6 state on the server may be due to a server malfunction.

An example business reason may be that the service provider 20 may wish to offer two contracts to customers, one with static IP addresses and one without static IP address. In this way, customers who require a static IP address because they wish to host a website, provide an email server, enable remote access to a host device, or maintain a constant voice over internet protocol (VoIP) connection, are charged higher rates for service.

If the service provider 20 issues a new address and the hosts 101 continue to use the old address, confusion in the network results, and packets may be dropped (notably return packets from network 10 to hosts 101 may be misrouted to another network device). In one scenario, packets are dropped because the first hop router of the service provider 20 may run unicast reverse path forwarding (uRPF) checks on the packet. uRPF checks block traffic from known invalid networks. A packet is forwarded only if the packet comes from the best route to the source of a packet as defined by routing or forwarding tables. uRPF is further defined by RFC 3704, released March 2004 and available at http://tools.ietf.org/html/rfc3704.

In order to prevent traffic from being dropped, the network device 100 may monitor the use of addresses by the hosts 101 following a network device reload. In one technique, the network device 100 recovers the old address and requests that the service provider 20 re-assign the old address. In another technique, the network device 100 identifies the old address and instructs the hosts 101 to invalidate the old address. These two techniques may be used separately or combined to seamlessly provide options given the terms of the service provider 20.

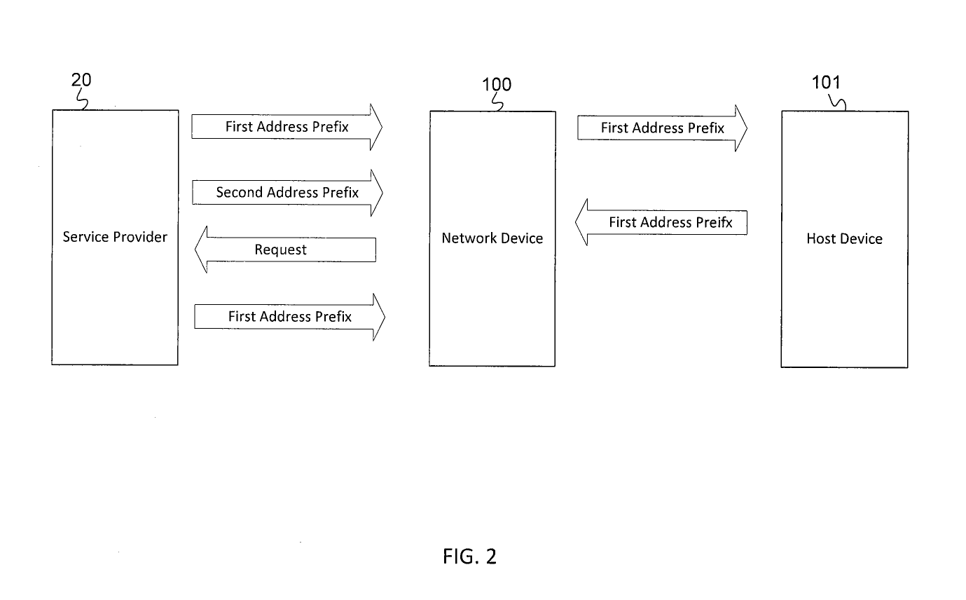

FIG. 2 illustrates an example embodiment of recovering addresses following a network device reload. As part of normal operation, the service provider 20 provides a first address prefix to the network device 100, which provides the first address prefix to the one or more hosts 101. When the network device 100 experiences a reboot or another reconnecting event, the first address prefix is cleared from the network device 100. However, the first address prefix may not be cleared from one or more of the hosts 101. The hosts 101 may continue to generate and transmit packets listing the first address prefix.

When the network device 100 reboots, the network device 100 may receive a second address prefix from the service provider 20, it can also delay its DHCPv6 prefix request for some time. However, the network device 100 does not advertise any address, but instead waits for traffic to be received from one or more of the hosts 101. During the delay, the network device 100 sends at least one advertisement message with an empty prefix list and a designation of the network device 100 as a default router. The delay may be a predetermined time period such as 1 second, 3 seconds, 10 seconds, or any amount of time. Alternatively, the network device 100 may delay sending network discovery messages until a predetermined number of packets are received from the hosts 101. The predetermined number may be one packet from each of the hosts 101.

From the traffic received from the hosts 101, the network device 100 is configured to algorithmically identify the address prefix that the hosts 101 consider valid. This identification may involve analyzing a packet to determine the source IP address prefix used by the hosts 101. If the hosts 101 still consider the first address prefix valid, the network device 100 sends a request to the service provider 20 requesting the first address prefix that was previously used be allocated to the network device 100 again. If the service provider 20 allocates again the first address prefix to the network device 100, traffic may continue with no changes implemented by the hosts 101. The second address prefix may be released.

This technique for recovering addresses following a network device reload may be implemented using any type of deployment. In the case of IPv6 rapid deployment (6rd), IPv6 is deployed across IPv4 infrastructures by using 32 bits of the IPv6 address space to map the entire IPv4 address space. The IPv6 addresses assigned to the hosts 101 are based on the IPv4 address of the interface on the wide area network (WAN). When the WAN's IPv4 address changes, IPv6 address of the host devices also changes. The network device 100 may attempt to request the old IPv4 address using DHCPv4 using the hint option.

In the case of DHCPv6 prefix delegation, not all operators use a centralized server, which results in the possibility that following an operational move, the network device 100 may receive a delegated prefix different from a previous prefix. In order to request the previous prefix, the network device 100 acts as a requesting router and may include the previous prefix in an Identity Association for Prefix Delegation (IA_PD), which contains a collection of prefixes assigned to the requesting router. The IA_PD request may be defined by RFC 3633, released December 2003 and available at http://tools.ietf.org/html/rfc3633. The IA_PD request may be used to request that the DHCPv6 server to re-assign a previous prefix if possible, even when the prefix length is different.

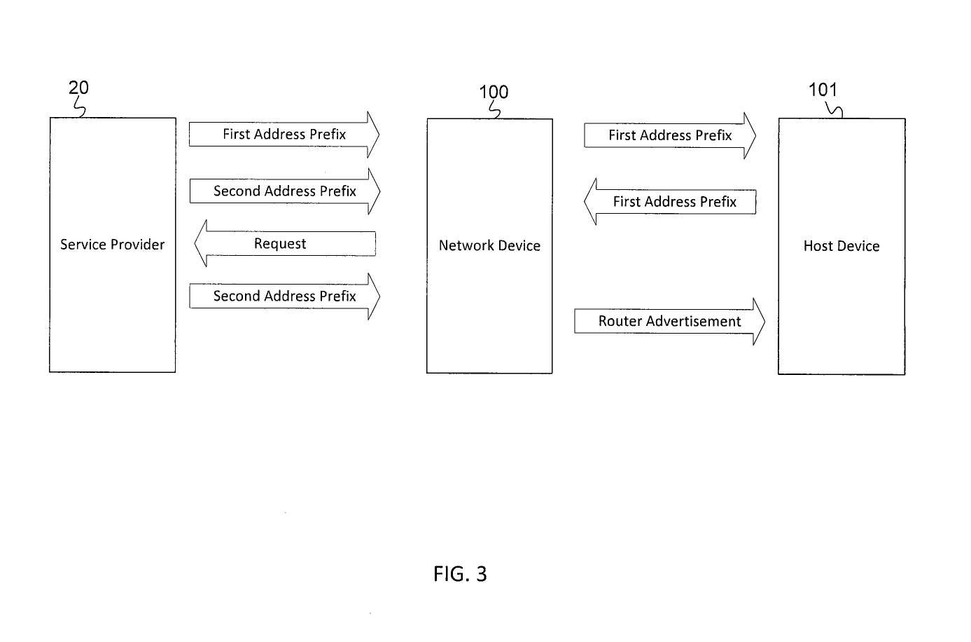

FIG. 3 illustrates an example embodiment where the service provider 20 requires cycling the addresses for business or technical reasons following a network device reload. When the service provider 20 does not allocate the first address prefix to the network device 100 but instead insists that the network device 100 distribute a second address prefix, the network device 100 sends a router advertisement to the hosts 101. The router advertisement indicates that the second address prefix is preferred and the first address prefix is not preferred.

For example, the router advertisement may include a preferred lifetime for the first address prefix of 0. Accordingly, the hosts 101 immediately stop using the first address prefix in all traffic sent to the network device 100. In addition, the router advertisement may include a nonzero preferred lifetime for the second address prefix. The nonzero preferred lifetime is the lifetime normally used by the network device 100 for valid packets. In other words, if the network device 100 experiences a reconnect event and the first address (old prefix) is included in traffic from the hosts 101 but the service provider 20 insists on providing the second address (new prefix), the network device 100 advertises the second address (new prefix) and informs the hosts 101 that the first address (old prefix) is no longer valid. The hosts 101 begin using the second address, and no packets following the network device reload are lost.

In addition, the network device 100 may be configured to disable recovering addresses after the network device reload and/or disable invalidating addresses following a network device reload. In one example, the network device 100 may disable the features automatically after detecting that other network devices exist on the home network. Such a multi-router setup may be detected when router advertisements are received from other routers. In another example, the network device 100 may disable the features based on a user input.

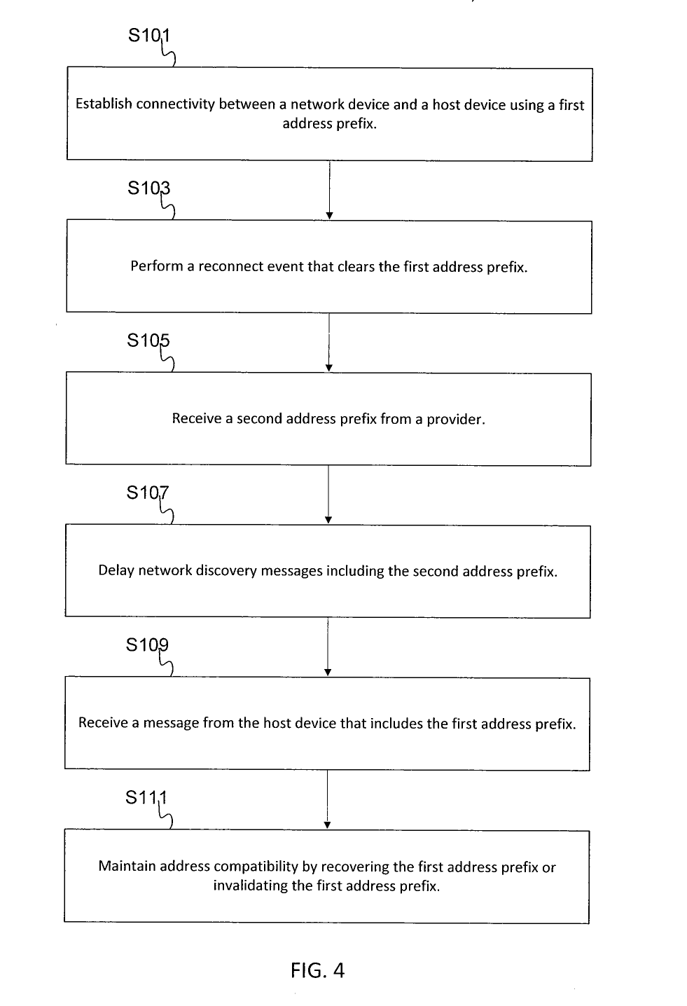

FIG. 4 illustrates a flow chart, according to one embodiment, for maintaining address compatibility in a network device reload. At S101, the network device 100 establishes connectivity with at least one host device 101 using a first address prefix. The first address prefix may be an IPv6 address or may be generated directly from an IPv4 address. The first address prefix was assigned to the network device 100 by the service provider 20.

The network device 100 enables the host device 101 to reach the external network 10 (e.g. the Internet). At S103, the network device 100 experiences a reconnect event, and the first address prefix is cleared from the network device 100. Accordingly, the network device 100 must reload addresses. The reconnect event may be a reboot resulting from a power outage or an upgrade.

At S105, the network device 100 receives a second address prefix from the service provider 20. The service provider 20 dictates whether or not to send the same address prefix either randomly based on the router or server connected to the network device 100 or intentionally in order to discriminate between static IP address subscribers and dynamic IP address subscribers.

At S107, the network device 100 delays the normal operation of sending network discovery messages with the new address prefix for a predetermined time period. Instead of immediately (e.g., after processing delay) advertising the new address prefix, the network device 100 waits to receive traffic from the host device 101. The wait may be a preset period or based on an event, such as receipt of one or more messages. At S109, the network device 100 receives a message from the host device 101 that includes the first address prefix. At S111, the network device 100 maintains address compatibility by recovering the first address prefix from the service provider 20 or invalidating the first address prefix using one or more router advertisements sent to the host device 101.

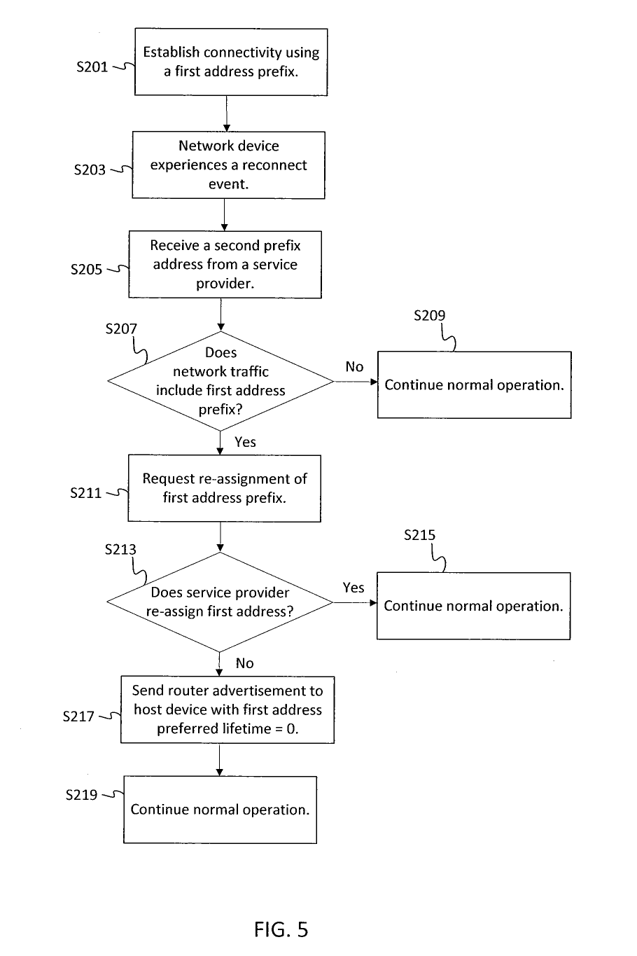

FIG. 5 is a more detailed flow chart for maintaining address compatibility in a network device reload. At S201, connectivity is established between the host device 101 and the external network 10 using a first address prefix. At S203, the network device 100 experiences a reconnect event. The reconnect event may be the result of a reboot by the end user, a malfunction, or an upgrade. The reconnect event may also be remotely initiated by the service provider 20. At S205, after the first prefix address has been cleared from the network device 100, the service provider 20 provides a second prefix address.

The network device 100 delays the normal transmission of discovery protocol messages (router advertisement which includes the second prefix address) for a predetermined time period or until an event occurs. During the delay time, the network device 100 receives traffic from the host device 101. At S207, the network device 100 analyzes the traffic received from hosts 101 for the first address prefix. This may involve recreating the first address prefix from a source IP address included in a packet received from the host device 101.

At S209, if the source IP address in the packet does include the second address prefix, the network device 100 reverts to normal operation in the communication with device provider 20 and host device 101. However, if the source IP address in the packet does not correspond to the second address prefix, the network device requests, at S211, that the service provider 20 re-assigned the first address prefix.

At S213, the network device 100 determines whether the service provider 20 re-assigned the first address prefix. If the service provider 20 provides the first address prefix to the network device 100, normal operation continues at S215. The host device 101 may not be informed that the second address prefix was ever assigned to the network.

At S217, if the service provider 20 does not provide the first address prefix to the network device 100, the network device 100 sends a router advertisement to the host devices 101 with the first address prefix associated with a first preferred lifetime and the second address prefix associated with a second preferred lifetime. The second preferred lifetime is greater that the first preferred lifetime. For example, the first preferred lifetime may be set to zero and the second preferred lifetime set to a nonzero integer number of seconds. In another example, the first preferred lifetime may be set to a few seconds (e.g. 2 seconds or 5 seconds) and the second preferred lifetime may be set to a default number of seconds (e.g., 604800 seconds to approximate one week, 2592000 seconds to approximate one month) or a value for infinity (e.g. 0×ffffffff) based on the information received from service provider 20.

Alternatively, the first preferred lifetime and the second preferred lifetime may be included in separate router advertisement messages. At S219, the network device 100 continues normal operation in facilitating communication between the host device 101 and the service provider 20. This solution is transparent to the end user and relies on no functionality on any of the hosts except the general adherence to RFC 4292, for example the version released April 2006 and available at http://tools.ietf.org/html/rfc4292, which has been adopted in most networks.

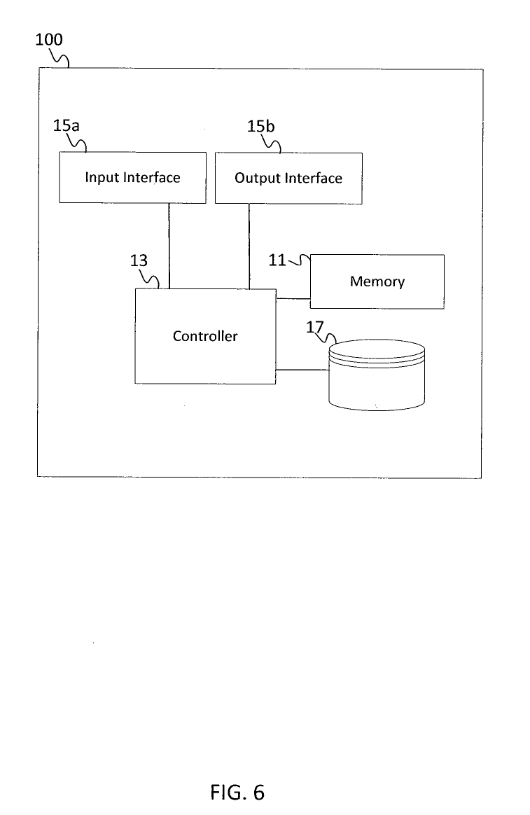

FIG. 6 illustrates a block diagram of the network device 100. The network device 100 includes a memory 11, a controller 13, and a communication interface 15. A database 17 may also be included. Additional, different, or fewer components may be provided. The network device 100 may be a residential gateway, wireless access point, a switch, or a network translation device.

The communication interface 15 may include an input communication interface 15a and an output communication interface 15b. The communication interface 15 is configured to establish connectivity with the host device 10 and the service provider 20 using the address prefix received from the service provider 20.

Either the memory 11 or the database 17 stores a network address translation table. The memory 100 may be a volatile memory that requires power maintain the address translation table, and is cleared automatically in the case of a reconnect event performed by the controller 13. The database 17 may be a permanent storage device subject to a command to clear the address translation table. The command may originate wither with the network device 100 or with the service provider 20.

After the reconnect event, the network device 100 reloads the network address translation table. The network device 100 may receive a second address from the service provider 20. The controller 13 is configured to delay transmission of network discovery messages including the second address prefix received from for the service provider. The delay may continue for a predetermined time period or until traffic is received from the host device 100. The traffic may include one or more packets including a source IP address associated with the first address prefix.

In order to maintain address compatibility after the reload, the controller 13 may request an address associated with the first address prefix from the service provider 20. If the service provider 20 does not provide such an address, the controller 13 is configured to generate a network discovery message with the address associated with the first address prefix to the host device 101. The network discovery message may be a router advertisement that sets a preferred lifetime of the first address prefix to zero or another relatively small value (e.g. 10 seconds). The router advertisement, or another router advertisement may set a preferred lifetime of the second address prefix to a default value. The default value may be any value up to infinity.

The memory 11 may be any known type of volatile memory or a non-volatile memory. The memory 11 may include one or more of a read only memory (ROM), dynamic random access memory (DRAM), a static random access memory (SRAM), a programmable random access memory (PROM), a flash memory, an electronic erasable program read only memory (EEPROM), static random access memory (RAM), or other type of memory.

The memory 11 may store computer executable instructions for the algorithms discussed herein. The controller 13 may execute the computer executable instructions. The computer executable instructions may be included in computer code. The computer code may be stored in the memory 11. The computer code may be written in any computer language, such as C, C++, C#, Java, Pascal, Visual Basic, Perl, HyperText Markup Language (HTML), JavaScript, assembly language, extensible markup language (XML) and any combination thereof. The computer code is encoded in one or more tangible media or one or more non-transitory tangible media for execution by the controller 13.

The instructions may be stored on any computer readable medium. A computer readable medium may include, but is not limited to, a floppy disk, a hard disk, an application specific integrated circuit (ASIC), a compact disk CD, other optical medium, a random access memory (RAM), a read only memory (ROM), a memory chip or card, a memory stick, and other media from which a computer, a processor or other electronic device can read.

The controller 13 may include a general processor, digital signal processor, application specific integrated circuit, field programmable gate array, analog circuit, digital circuit, server processor, combinations thereof, or other now known or later developed processor. The controller 13 may be a single device or combinations of devices, such as associated with a network or distributed processing. Any of various processing strategies may be used, such as multi-processing, multi-tasking, parallel processing, remote processing, centralized processing or the like. The controller 13 may be responsive to or operable to execute instructions stored as part of software, hardware, integrated circuits, firmware, micro-code or the like. The functions, acts, methods or tasks illustrated in the figures or described herein may be performed by the controller 13 executing instructions stored in the memory 11. The functions, acts, methods or tasks are independent of the particular type of instructions set, storage media, processor or processing strategy and may be performed by software, hardware, integrated circuits, firmware, micro-code and the like, operating alone or in combination. The instructions are for implementing the processes, techniques, methods, or acts described herein.

The I/O interface(s) 15a-b may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other or through one or more intermediate entities (e.g., processor, operating system, logic, software). Logical and/or physical communication channels may be used to create an operable connection. For example, the I/O interface(s) 15a-b may include a first communication interface devoted to sending data, packets, or datagrams and a second communication interface devoted to receiving data, packets, or datagrams. Alternatively, the I/O interface(s) 15a-b may be implemented using a single communication interface.

The communication links may be any protocol or physical connection that is used to couple a server to a computer. The communication paths may utilize Ethernet, wireless, transmission control protocol (TCP), Internet protocol (IP), or multiprotocol label switching (MPLS) technologies. As used herein, the phrases “in communication” and “coupled” are defined to mean directly connected to or indirectly connected through one or more intermediate components. Such intermediate components may include both hardware and software based components.

Various embodiments described herein can be used alone or in combination with one another. The foregoing detailed description has described only a few of the many possible implementations of the present disclosure. For this reason, this description of example embodiments is intended by way of illustration, and not by way of limitation.

I (we) claim:

1. A method by one or more computer systems, the method comprising:
as part of a reconnect event, clearing, from a memory of a network device, a first address prefix being used at least in part to provide connectivity between the network device and at least one host device;
receiving a second address prefix from a provider;
delaying transmission of a network discovery message including the second address prefix for a period; and
receiving a message from the at least one host device during the period, wherein the message includes the first address prefix.

2. The method of claim 1, further comprising:
requesting an address from the provider; and
sending a network discovery message with the address to the at least one host device, if the provider provides an address associated with the first address prefix.

3. The method of claim 2, further comprising:
sending a router advertisement message to the at least one host device, if the provider provides an address associated with the second address prefix, wherein the router advertisement message lists a first preferred lifetime of the first address prefix and a second preferred lifetime of the second address prefix.

4. The method of claim 3, wherein the second preferred lifetime exceeds the first preferred lifetime.

5. The method of claim 4, wherein the first preferred lifetime is zero.

6. The method of claim 1, wherein the network device is a residential gateway or consumer premises equipment.

7. The method of claim 1, wherein the reconnect event initiates a boot sequence.

8. The method of claim 1, wherein the reconnect event is independent of a boot sequence.

9. A network device comprising:
a communication interface for establishing connectivity with at least one host device using a first address prefix received from a service provider; and
a controller configured to perform a reconnect event, wherein the first address prefix is cleared from the network device as part of the reconnect event, and configured to delay transmission of a network discovery message including a second address prefix received from for the service provider.

10. The network device of claim 9, wherein the communication interface receives a message from the at least one host device during the delay, wherein the message includes the first address prefix.

11. The network device of claim 10, wherein the controller is further configured to request an address associated with the first address prefix from the service provider.

12. The network device of claim 10, wherein the controller is configured to generate a network discovery message with the address associated with the first address prefix for transmission to the at least one host device, if the provider provides the address associated with the first address prefix.

13. The network device of claim 10, wherein the controller is configured to generate a router advertisement message to the at least one host device, if the provider provides an address associated with the second address prefix, wherein the router advertisement message lists a first preferred lifetime of the first address prefix and a second preferred lifetime of the second address prefix.

14. The network device of claim 13, wherein the second preferred lifetime exceeds the first preferred lifetime.

15. The network device of claim 14, wherein the first preferred lifetime is zero and the second preferred lifetime is a nonzero integer.

16. The network device of claim 14, wherein the reconnect event is a boot sequence, an upgrade, or a power cycle.

17. One or more computer readable storage media encoded with software comprising computer executable instructions and when the software is executed operable to:
communicate with at least one host device using a first address prefix;
receive a second address prefix from an external device; and
receive a message including the first address prefix from the at least one host device during a delay period after receiving the second address prefix, wherein the transmission of a network discovery message including the second address prefix is prevented during the delay period.

18. The one or more computer readable storage media of claim 17, further comprising instructions operable to:
request an address associated with the first address prefix from the external device.

19. The one or more computer readable storage media of claim 18, further comprising instructions operable to:
send a network discovery message with the address associated with the first address prefix to the at least one host device, if the external device provides the address associated with the first address prefix.

20. The one or more computer readable storage media of claim 19, further comprising instructions operable to:
send a router advertisement message to the at least one host device, if the external device provides the address associated with the second address prefix, wherein the router advertisement message lists a first preferred lifetime of the first address prefix and a second preferred lifetime of the second address prefix.
